(19) United States
(12) Patent Application Publication
(10) Pub. No.: US 2009/0327776 A1
(43) Pub. Date: Dec. 31, 2009

(54) MULTIPLE LOAD LINE VOLTAGE REGULATORS

(76) Inventor: Don J. Nguyen, Portland, OR (US)

Correspondence Address: Caven & Aghevli LLC;c/o CPA Global, P.O. BOX 52050, MINNEAPOLIS, MN, 55402, US

(21) Appl. No.: 12/165,231

(22) Filed: Jun. 30, 2008

(51) Int. Cl. G06F 1/32; G05F 1/56

(52) U.S. Cl. 713/320; 323/283

(57) ABSTRACT

Methods and apparatus relating to a multiple load line voltage regulators are described. In one embodiment, a voltage regulator may adjust an input voltage level based on information received from a load and current supplied to the load. Other embodiments are also disclosed and claimed.

### FIELD

The present disclosure generally relates to the field of electronics. More particularly, an embodiment of the invention relates to a multiple load line voltage regulator.

### BACKGROUND

Portable computing devices are quickly gaining popularity in part due to their size. Since most portable computing devices rely on batteries to operate, efficient use of battery power can become a critical issue. For example, inefficient use of power in a portable computing device may shorten the period during which the device may of use to a user. Also, inefficient power usage may result in heat generation which may, in turn, damage the electronic components of the computing device.

In some computing devices, processors may consume a large portion of the available power. For example, in a portable computing device (such as a laptop computer or personal digital assistant (PDA)), the processor may be the highest or one of the highest power consuming components. However, the trend appears to be toward providing ever-increasing computing power in computing devices, for example, to meet the increasing demand for various computation-intensive applications.

Accordingly, regulating power consumption (by a processor or other components in a computing device) has become one of the main goals for designers today.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1, 6, and 7 illustrate block diagrams of embodiments of computing systems, which may be utilized to implement various embodiments discussed herein.

FIG. 2 illustrates a block diagram of a switching voltage regulator, according to an embodiment of the invention.

FIGS. 3 and 4 illustrate graphics of voltage versus current, according to some embodiments.

FIG. 5 illustrates a flow diagram of an embodiment of a method to regulate voltage supplied to a component of a computing system.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs (“software”), or some combination of hardware and software. For the purposes of this disclosure reference to “logic” shall mean either hardware, software, or some combination thereof.

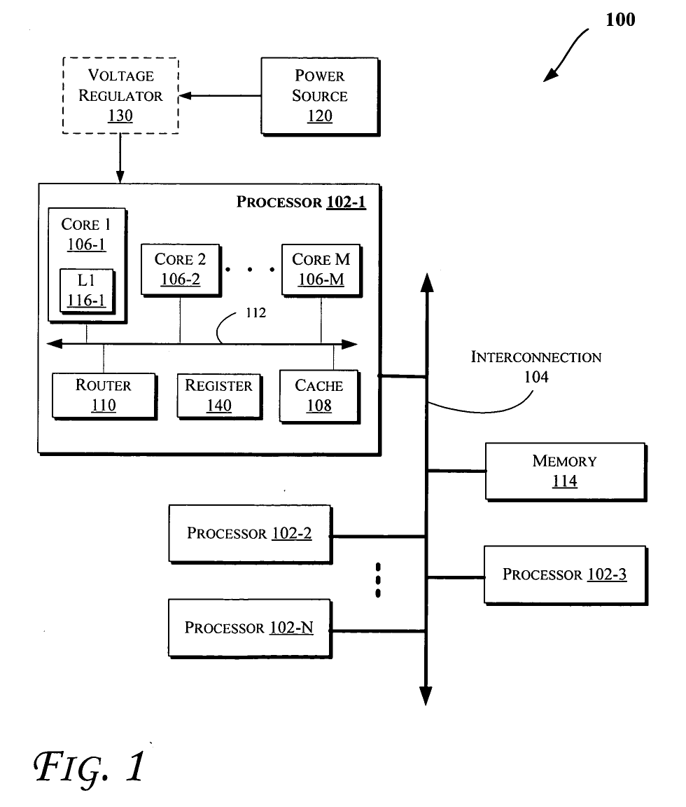

Some of the embodiments discussed herein may provide an efficient multiple load line voltage regulator (VR), e.g., by improving power-conversion efficiency in a VR, reduction of power dissipation, extension of platform battery life, etc. In particular, with increased emphasis on lowering power consumption of electronic components in computing systems (such as portable and handheld systems), more and more scrutiny is being applied to power consumed by components (e.g., a processor) which may not be running at full power constantly. In an embodiment, a voltage regulator may adjust an input voltage level based on information received from a load and current supplied to the load. Moreover, some embodiments may be applied in computing systems that include one or more processors (e.g., with one or more processor cores), such as those discussed with reference to FIGS. 1-7.

More particularly, FIG. 1 illustrates a block diagram of a computing system 100, according to an embodiment of the invention. The system 100 may include one or more processors 102-1 through 102-N (generally referred to herein as “processors 102” or “processor 102”). The processors 102 may communicate via an interconnection or bus 104. Each processor may include various components some of which are only discussed with reference to processor 102-1 for clarity. Accordingly, each of the remaining processors 102-2 through 102-N may include the same or similar components discussed with reference to the processor 102-1.

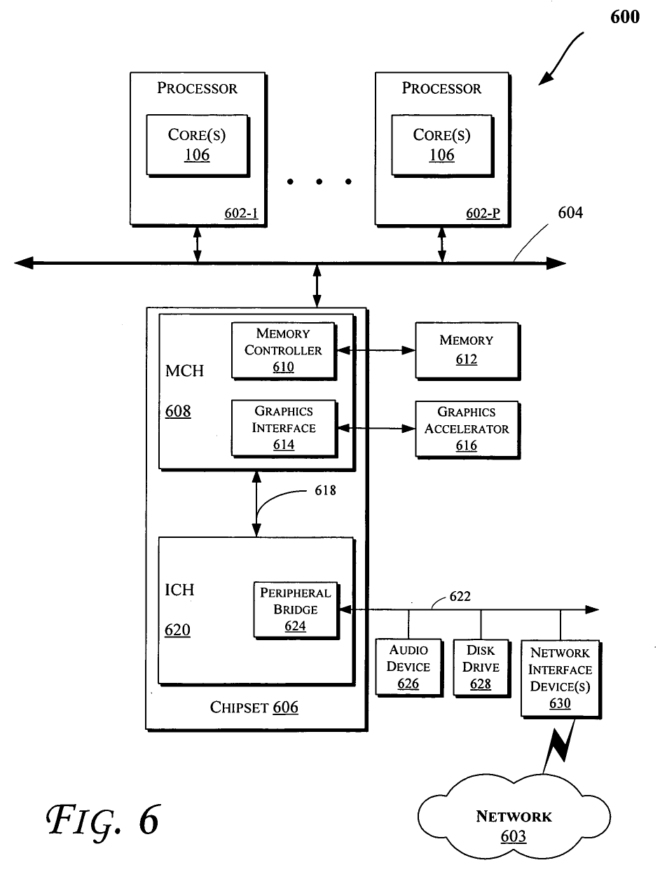

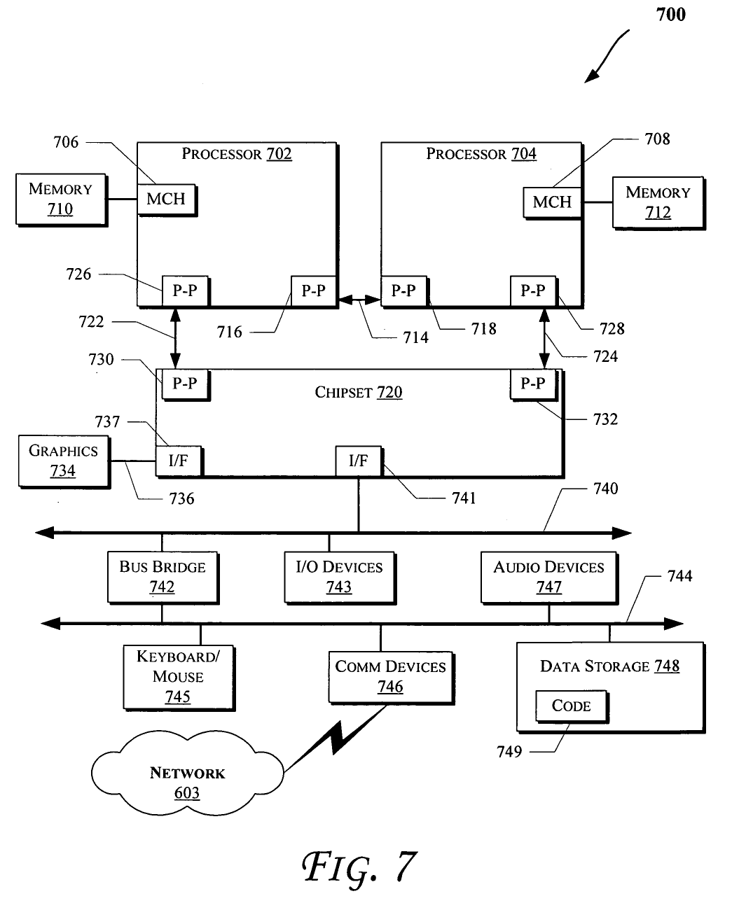

In an embodiment, the processor 102-1 may include one or more processor cores 106-1 through 106-M (referred to herein as “cores 106,” or “core 106”), a cache 108, and/or a router 110. The processor cores 106 may be implemented on a single integrated circuit (IC) chip. Moreover, the chip may include one or more shared and/or private caches (such as cache 108), buses or interconnections (such as a bus or interconnection 112), memory controllers (such as those discussed with reference to FIGS. 6-7), or other components.

In one embodiment, the router 110 may be used to communicate between various components of the processor 102-1 and/or system 100. Moreover, the processor 102-1 may include more than one router 110. Furthermore, the multitude of routers 110 may be in communication to enable data routing between various components inside or outside of the processor 102-1.

The cache 108 may store data (e.g., including instructions) that are utilized by one or more components of the processor 102-1, such as the cores 106. For example, the cache 108 may locally cache data stored in a memory 114 for faster access by the components of the processor 102 (e.g., faster access by cores 106). As shown in FIG. 1, the memory 114 may communicate with the processors 102 via the interconnection 104. In an embodiment, the cache 108 (that may be shared) may be a mid-level cache (MLC), a last level cache (LLC), etc. Also, each of the cores 106 may include a level 1 (L1) cache (116-1) (generally referred to herein as “L1 cache 116”) or other levels of cache such as a level 2 (L2) cache. Moreover, various components of the processor 102-1 may communicate with the cache 108 directly, through a bus (e.g., the bus 112), and/or a memory controller or hub.

The system 100 may also include a power source 120 (e.g., a direct current (DC) power source or an alternating current (AC) power source) to provide power to one or more components of the system 100. In some embodiments, the power source 120 may include one or more battery packs. The power source 120 may be coupled to components of system 100 through a voltage regulator (VR) 130. Moreover, even though FIG. 1 illustrates one power source 120 and one voltage regulator 130, additional power sources and/or voltage regulators may be utilized. For example, each of the processors 102 may have corresponding voltage regulator(s) and/or power source(s).

Additionally, while FIG. 1 illustrates the power source 120 and the voltage regulator 130 as separate components, the power source 120 and the voltage regulator 130 may be incorporated into other components of system 100. For example, all or portions of the VR 130 may be incorporated into the power source 120 and/or processor 102.

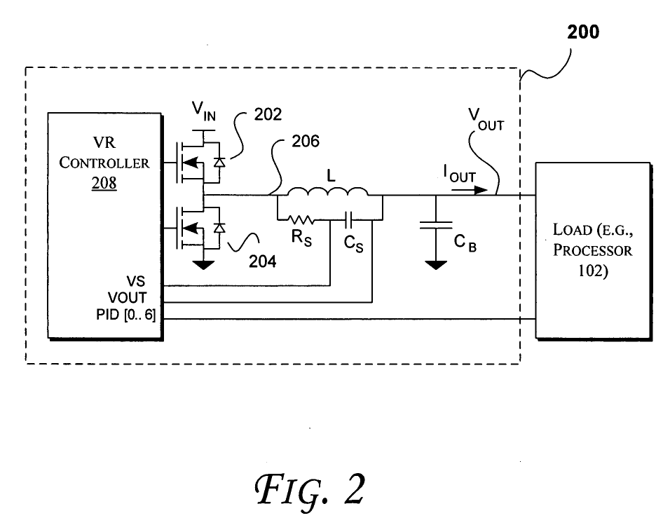

Referring to FIG. 2, a block diagram of a Switching Voltage Regulator (SVR) 200 is illustrated, according to an embodiment. The SVR 200 may be used to regulate or control an unregulated input voltage (e.g., voltage supplied by a power source such as power source 120 discussed with reference to FIG. 1) at node V_{IN} (e.g., at about 9-12.6V range for a battery power source) to a regulated output voltage at node V_{OUT} (e.g., 1V for a battery power source) to power one or more components of a computing system (such as the computing systems discussed herein with reference to FIGS. 1, 6, and 7, including for example, the core rail of a processor (such as processor 102 of FIG. 1)). The SVR may employ N-Channel MOSFETs (Metal Oxide Semiconductor FET (Field-Effect Transistors)) 202 (pull-up transistor) and 204 (pull-down transistor), or other types of transistors (e.g., FETs or P-Channel FETs or MOSFETs depending on the implementation), used to switch in the V_{IN} voltage to the input side of the magnetic inductor L (206) periodically (e.g., at about 300 kHz) to cause the current flow in the inductor L to ramp up or down.

As shown in FIG. 2, the output capacitor CB may be used to smooth out the inductor L ripple current and/or to provide an average voltage at the output node V_{OUT}. To sense the output load current I_{OUT}, a VR controller 208 may measure the voltage across the Cₛ capacitor (thorough inputs VS and V_{OUT} in an embodiment), which represents the DC voltage across the inductor L and its associated DC resistance (DCR). Since the DCR of the inductor L is known, the VR controller 202 may divide the voltage of Cₛ by the DCR of the inductor L to determine the output current demand (e.g., for the processor 102). In some embodiments, output current information may be used to determine the condition of the Over-Current Protection level or to set the voltage response of the VR according to the load condition. This may be referred to as the Load-Line design methodology.

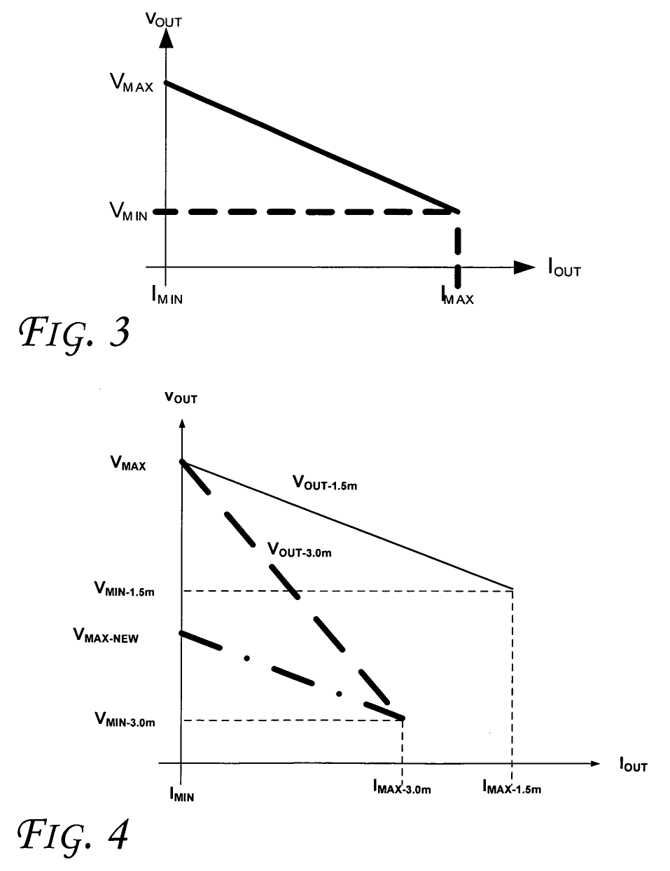

In some embodiments, a processor may be designed to accept a voltage with a Load-Line methodology. For example, referring to FIG. 3, a sample Load-Line specification is shown according to an embodiment. As shown in FIG. 3, the output voltage V_{OUT} supplied to a processor (such as processor 102 of FIG. 1) may be reduced when its loading current is increased. This Load-Line method may help to reduce processor power and VR output decoupling. In accordance with some embodiments, VR design might however be required to provide different Load-Line depending on processor's requirements such as its power rating (whether dynamically (e.g., during processor operation) or statically (e.g., during platform initialization, for example when a computing platform or system senses coupling of a processor or another component).

To change the Load-Line, platform designers may tune and optimize the design of the VR. For example, in the case of a 1.5 mΩ Load-Line design, a combination of 6×330 uF-9mΩ bulk capacitors may be used. In the case of a 3 mΩ Load-Line design, the designers might choose a combination of 3×330 uF-9 mΩ bulk capacitors. This will reduce the cost and space of the bulk capacitors by half. One issue with this method (of specifically tuned/optimized the VR design to meet a specific Load-Line requirement) is the design/platform inventory. That is an OEM (Original Equipment Manufacturer) or ODM (Original Design Manufacturer) needs to manufacture and keep in their inventory multiple SKUs (Stock Keeping Units). To address this, OEM/ODM might elect to design a platform that utilizes just one Load-Line since the cost of inventory multiple (Load-Line) SKU might outweigh the cost of reduction in bulk capacitor. As such, they would design the VR to support the most stringent Load-Line requirement (the smallest Load-Line, for example the 1.5 mΩ in the above example) and use this for all their SKU. However, power saving (with the higher Load-Line requirement) is important in some implementations and designers generally aim to maximize power saving of a higher Load-Line design.

Furthermore, in some embodiments, to realize the power-saving benefit, a system designer/manufacturer might provide an offset (e.g., negative) voltage to the output of the VR for the higher Load-Line components such as a processor. The offset voltage may be designed to ensure that at the maximum current demand of the higher Load-Line processor, its minimum voltage specification is satisfied. To this end, FIG. 4 illustrates a graph of VR output voltage versus output current, in accordance with one embodiment.

As shown in FIG. 4, the offset in this example is the delta between V_{MAX} and V_{MAX-NEW}, e.g., since during some usage models, the processor is not at the maximum current level all the time. In some implementations, since most of the time the processor is at the minimum current level, the techniques discussed herein may provide a much lower voltage than that of a 3 mΩ design, which in turn would reduce the power to the processor. Even for a “thermally-stress” condition (e.g., defined as 70%-80% of maximum power level), the voltage supplied to the processor may still be much lower than that of the 3 mΩ design and as a result power consumption may be significantly reduced.

In one embodiment, the VR may be informed of the Load-Line requirement for one or more specific components (e.g., one or more of processors 102) that has just been plugged into the platform. In some embodiments, the processor(s) or component(s) may provide the information to the VR, e.g., via an identification mechanism such as one or more pins, which may interchangeably be referred to herein as lines, I/O lines, or nodes (e.g., PID[0 . . . 6], which indicates 7 bits are used in an embodiment, but more or less bits may be used for this purpose), a register setting that may be read by the computing platform, etc. For example, one or more bits stored in a register 140 of FIG. 1 may be used for such purposes or one or more bits may be stored in any of the storage devices of a processor such as those discussed with reference to FIG. 1. Register 140 may or may not be coupled to the bus 112 in various embodiments. Also, register 140 may be coupled to one or more pins of VR of FIG. 2 (e.g., Power Identifier (PID)) in an embodiment.

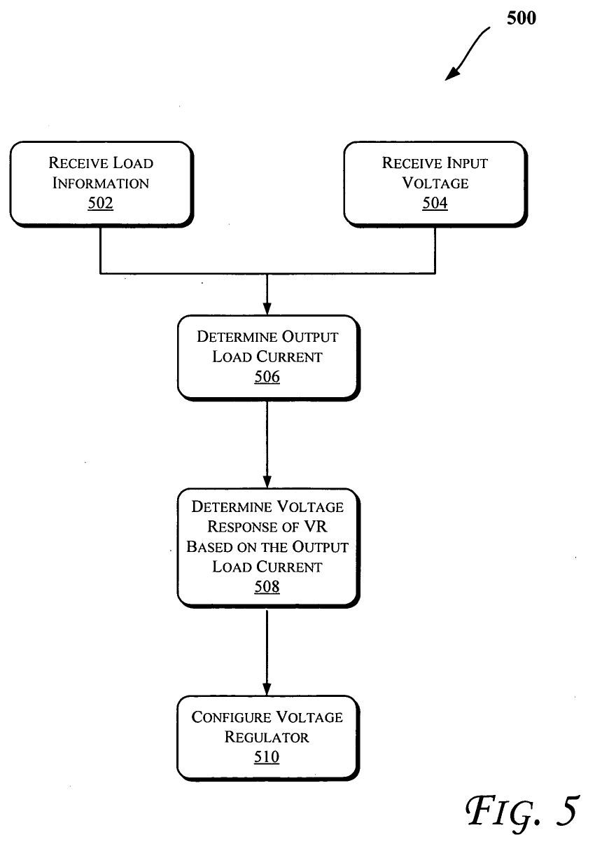

FIG. 5 illustrates a flow diagram of an embodiment of a method 500 to regulate voltage supplied to a component of a computing system (such as a processor). In an embodiment, various components discussed with reference to FIGS. 1-4 and 6-7 may be utilized to perform one or more of the operations discussed with reference to FIG. 5.

Referring to FIGS. 1-5, at an operation 502, information regarding a load (e.g., power rating) may be received by a voltage regulator. In an embodiment, at operation 502, information regarding processor 102 (e.g., stored in the storage units of the processor, such as the register 140) may be received by the VR controller 208 (e.g., via at least one pin, such as PID). At an operation 504, input voltage may be received by the voltage regulator (e.g., V_{IN} of SVR 200). Operations 502 and 504 may be performed in any order. Also, the load information of operation 502 may be received and/or updated at any point during operation of the load or during initialization, such as discussed herein with reference to FIG. 2 for example.

At an operation 506, the output load current may be determined. For example, as discussed with reference to FIG. 2, the I_{OUT} may be determined based on the voltage across Cₛ and value of Rₛ. At an operation 508, the voltage response for the voltage regulator may be determined based on the output load current of operation 506 and/or the load information of operation 502. At an operation 510, the voltage regulator may be configured, e.g., based on the determined voltage response of operation 508.

FIG. 6 illustrates a block diagram of a computing system 600 in accordance with an embodiment of the invention. The computing system 600 may include one or more central processing unit(s) (CPUs) or processors 602-1 through 602-P (which may be referred to herein as “processors 602” or “processor 602”). The processors 602 may communicate via an interconnection network (or bus) 604. The processors 602 may include a general purpose processor, a network processor (that processes data communicated over a computer network 603), or other types of a processor (including a reduced instruction set computer (RISC) processor or a complex instruction set computer (CISC)). Moreover, the processors 602 may have a single or multiple core design. The processors 602 with a multiple core design may integrate different types of processor cores on the same integrated circuit (IC) die. Also, the processors 602 with a multiple core design may be implemented as symmetrical or asymmetrical multiprocessors. In an embodiment, one or more of the processors 602 may be the same or similar to the processors 102 of FIG. 1. In some embodiments, one or more of the processors 602 may include one or more of the cores 106 of FIG. 1 and/or cache 108 of FIG. 1. Also, the operations discussed with reference to FIGS. 1-5 may be performed by one or more components of the system 600. For example, a voltage regulator (such as VR 130 of FIG. 1 or SVR 200 of FIG. 2) may regulate voltage supplied to one or more components of FIG. 6.

A chipset 606 may also communicate with the interconnection network 604. The chipset 606 may include a memory control hub (MCH) 608. The MCH 608 may include a memory controller 610 that communicates with a memory 612. The memory 612 may store data, including sequences of instructions that are executed by the processor 602, or any other device included in the computing system 600. In one embodiment of the invention, the memory 612 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 604, such as multiple CPUs and/or multiple system memories.

The MCH 608 may also include a graphics interface 614 that communicates with a graphics accelerator 616. In one embodiment of the invention, the graphics interface 614 may communicate with the graphics accelerator 616 via an accelerated graphics port (AGP). In an embodiment of the invention, a display (such as a flat panel display, a cathode ray tube (CRT), a projection screen, etc.) may communicate with the graphics interface 614 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display.

A hub interface 618 may allow the MCH 608 and an input/output control hub (ICH) 620 to communicate. The ICH 620 may provide an interface to I/O devices that communicate with the computing system 600. The ICH 620 may communicate with a bus 622 through a peripheral bridge (or controller) 624, such as a peripheral component interconnect (PCI) bridge, a universal serial bus (USB) controller, or other types of peripheral bridges or controllers. The bridge 624 may provide a data path between the processor 602 and peripheral devices. Other types of topologies may be utilized. Also, multiple buses may communicate with the ICH 620, e.g., through multiple bridges or controllers. Moreover, other peripherals in communication with the ICH 620 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 622 may communicate with an audio device 626, one or more disk drive(s) 628, and one or more network interface device(s) 630 (which is in communication with the computer network 603). Other devices may communicate via the bus 622. Also, various components (such as the network interface device 630) may communicate with the MCH 608 in some embodiments of the invention. In addition, the processor 602 and the MCH 608 may be combined to form a single chip. Furthermore, the graphics accelerator 616 may be included within the MCH 608 in other embodiments of the invention.

Furthermore, the computing system 600 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 628), a floppy disk, a compact disk ROM (CD-ROM), a digital versatile disk (DVD), flash memory, a magneto-optical disk, or other types of nonvolatile machine-readable media that are capable of storing electronic data (e.g., including instructions). In an embodiment, components of the system 600 may be arranged in a point-to-point (PtP) configuration. For example, processors, memory, and/or input/output devices may be interconnected by a number of point-to-point interfaces.

FIG. 7 illustrates a computing system 700 that is arranged in a point-to-point (PtP) configuration, according to an embodiment of the invention. In particular, FIG. 7 shows a system where processors, memory, and input/output devices are interconnected by a number of point-to-point interfaces. The operations discussed with reference to FIGS. 1-6 may be performed by one or more components of the system 700. For example, a voltage regulator (such as VR 130 of FIG. 1 or SVR 200 of FIG. 2) may regulate voltage supplied to one or more components of FIG. 7.

As illustrated in FIG. 7, the system 700 may include several processors, of which only two, processors 702 and 704 are shown for clarity. The processors 702 and 704 may each include a local memory controller hub (MCH) 706 and 708 to enable communication with memories 710 and 712. The memories 710 and/or 712 may store various data such as those discussed with reference to the memory 612 of FIG. 6. As shown in FIG. 7, the processors 702 and 704 may also include one or more cache(s) discussed with reference to FIG. 6.

In an embodiment, the processors 702 and 704 may be one of the processors 602 discussed with reference to FIG. 6. The processors 702 and 704 may exchange data via a point-to-point (PtP) interface 714 using PtP interface circuits 716 and 718, respectively. Also, the processors 702 and 704 may each exchange data with a chipset 720 via individual PtP interfaces 722 and 724 using point-to-point interface circuits 726, 728, 730, and 732. The chipset 720 may further exchange data with a high-performance graphics circuit 734 via a high-performance graphics interface 736, e.g., using a PtP interface circuit 737.

In at least one embodiment, one or more operations discussed with reference to FIGS. 1-6 may be performed by the processors 702 or 704 and/or other components of the system 700 such as those communicating via a bus 740. Other embodiments of the invention, however, may exist in other circuits, logic units, or devices within the system 700 of FIG. 7. Furthermore, some embodiments of the invention may be distributed throughout several circuits, logic units, or devices illustrated in FIG. 7.

Chipset 720 may communicate with the bus 740 using a PtP interface circuit 741. The bus 740 may have one or more devices that communicate with it, such as a bus bridge 742 and I/O devices 743. Via a bus 744, the bus bridge 742 may communicate with other devices such as a keyboard/mouse 745, communication devices 746 (such as modems, network interface devices, or other communication devices that may communicate with the computer network 603), audio I/O device, and/or a data storage device 748. The data storage device 748 may store code 749 that may be executed by the processors 702 and/or 704.

In various embodiments of the invention, the operations discussed herein, e.g., with reference to FIGS. 1-7, may be implemented as hardware (e.g., logic circuitry), software, firmware, or combinations thereof, which may be provided as a computer program product, e.g., including a machine-readable or computer-readable medium having stored thereon instructions (or software procedures) used to program a computer to perform a process discussed herein. The machine-readable medium may include a storage device such as those discussed with respect to FIGS. 1-7.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising:
a load; and
a storage device to store one or more bits indicative of a power rating of the load,
wherein a voltage regulator is to to supply a regulated output voltage to the load and to adjust the output voltage based on the one or more bits.

2. The apparatus of claim 1, wherein the voltage regulator comprises a voltage regulator controller to receive the one or more bits over at least one node and to cause the voltage regulator to control a level of the output voltage based on the one or more bits.

3. The apparatus of claim 1, wherein the voltage regulator comprises a voltage regulator controller to determine an output current through the load and to cause the voltage regulator to control a level of the output voltage based on the output current.

4. The apparatus of claim 1, wherein the voltage regulator comprises a voltage regulator controller to:
receive the one or more bits over at least one node;
determine an output current through the load; and
cause the voltage regulator to control a level of the output voltage based on both of: the one or more bits and the output current.

5. The apparatus of claim 1, further comprising a power source coupled to the voltage regulator to supply an input voltage, wherein the voltage regulator is to regulate the input voltage to supply the output voltage.

6. The apparatus of claim 5, wherein the voltage regulator comprises a voltage regulator controller to receive the one or more bits over at least one node and to cause the voltage regulator to control a level of the output voltage based on the one or more bits and the input voltage.

7. The apparatus of claim 5, wherein the voltage regulator comprises a transistor and a voltage regulator controller, wherein the transistor is to couple the input voltage to the voltage regulator controller.

8. The apparatus of claim 7, wherein the voltage regulator comprises an inductor coupled between transistor and the load, wherein the voltage regulator controller is to sense a output current to flow across the inductor and wherein the voltage regulator controller is to cause the voltage regulator to control a level of the output voltage based on both of: the one or more bits and the output current.

9. The apparatus of claim 7, wherein the transistor comprises a field-effect transistor.

10. The apparatus of claim 1, wherein the load comprises a processor.

11. The apparatus of claim 10, wherein the processor comprises one or more processor cores.

12. The apparatus of claim 1, wherein the load is to comprise the storage device.

13. A method comprising:
receiving information regarding power rating of a load;
determining a level of output current corresponding to the load; and
configuring a voltage regulator based on the received information and the determined output current.

14. The method of claim 13, wherein determining the level of the output current further comprises sensing a voltage level across a capacitor coupled between the load and a voltage regulator controller of the voltage regulator.

15. The method of claim 13, further comprising transmitting the information from the load to the voltage regulator.

16. The method of claim 13, wherein configuring the voltage regulator is performed during operation of the load or at initialization.

17. A system comprising:
a storage device to store one or more bits indicative of a power rating of a processor;
a voltage regulator coupled between the processor and a power source, the voltage regulator to comprise a voltage regulator controller to:
receive the one or more bits; and
cause the voltage regulator to adjust an output voltage to the processor based on the one or more bits.

18. The system of claim 17, wherein the voltage regulator controller is to:
sense an output current to the processor; and
cause the voltage regulator to adjust the output voltage to the processor based on the sensed output current.

19. The system of claim 17, wherein the power source is to be coupled to the voltage regulator to supply an input voltage, wherein the voltage regulator is to regulate the input voltage to supply the output voltage.

20. The system of claim 17, further comprising an audio device.
